(19) United States
(12) Patent Application Publication
(10) Pub. No.: US 2009/0233657 A1
(43) Pub. Date: Sep. 17, 2009

(54) FOLDING MOBILE RADIO DEVICE

(75) Inventor: Kenji Ogawa, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 11/908,867

(22) PCT Filed: Oct. 4, 2005
(86) PCT No.: PCT/JP2005/018363

§ 371 Date: Sep. 17, 2007

(51) Int. Cl. H04M 1/00

(52) U.S. Cl. 455/575.3

(57) ABSTRACT

Even when a case is held to tilt at any angle to the ground, a high gain can be implemented and a SAR reducing effect can be achieved and also frequencies in multiple bands can be handled.

A configuration of three antenna elements consisting of a planar element 16 arranged in a lower case 12 in the width direction of the case, a planar element 17 arranged in an upper case 11 in the longitudinal direction of the case to have a wide antenna area, and a planar element 18 arranged in the upper case 11 in parallel with the planar element 16 is employed such that the planar element 16 is coupled with the planar element 17 via a capacitive coupling and also coupled with the planar element 18 via an electromagnetic coupling in the opened state of the case. Also, the planar element 16 is connected to a radio circuit 14 on a circuit board 13 having the ground pattern via a matching circuit 15.

### TECHNICAL FIELD

The present invention relates to a folding mobile radio device equipped with an antenna that has a high gain and a low specific absorption rate (SAR) and is capable of handling multiple frequency bands.

### BACKGROUND ART

The mobile radio device, e.g., the cellular phone is now widespread. Various types of cellular phones have already been developed. Out of them, a compact foldable cellular phone whose portability can be increased by folding upper and lower cases (referred to as a “folding cellular phone” hereinafter) is used widely. This folding cellular phone has a case structure of open/close type, and can be used while the case portion is held in either of its opened state and its closed state. Therefore, a desired antenna performance must be ensured in respective states. Also, in order to improve a size reduction and a design property, the use of a built-in antenna is advanced in this cellular phone, or the like. Therefore, various types of built-in antennas have been developed and employed.

As the recent folding cellular phone equipped with the built-in antenna, the phone set forth in Patent Literature 1, for example, is well known. More particularly, as shown in FIG. 11, this folding cellular phone has an upper case 101, a lower case 102, a conductive plate 103 built in the upper case 101, and a conductive plate 104 built in the lower case 102. Also, a high-frequency power source 105 connected to the conductive plate 103 and the conductive plate 104 is arranged in the lower case 102. In the folding cellular phone having such configuration, the conductive plate 103 and the conductive plate 104 constitute the built-in antenna and operate as a dipole antenna, so that a size reduction of the cellular phone can be achieved.

Also, as another folding cellular phone equipped with the built-in antenna, the phone set forth in Patent Literature 2, for example, is also well known. More particularly, as shown in FIG. 12, this folding cellular phone has an upper case 201 and a lower case 202, and has a dipole antenna 203 and an opposing element 204 on the plane that is parallel with a plane of the upper case 201 to which an earpiece portion is provided. Also, the dipole antenna 203 and the opposing element 204 are connected to a high-frequency power source 207 via a short-circuit portion 205 and a short-circuit portion 206, and are arranged such that both ends of the dipole antenna 203 and the opposing element 204 are folded respectively in the direction to go away mutually. Also, a parasitic element 208 and a parasitic element 209 are arranged in close vicinity of the dipole antenna 203 and the opposing element 204 respectively, and are arranged on the same plane such that both ends of the parasitic element 208 and the parasitic element 209 are folded respectively in the direction to go away mutually. Such folding cellular phone is constructed not to direct the radiation pattern to the user (human body) side, so that an effect of suppressing a dielectric loss and a matching loss during the phone call can be attained.

### Patent Literature 1: JP-A-2004-208219

### Patent Literature 2: JP-A-1001-33491

### DISCLOSURE OF THE INVENTION

Problems that the Invention is to Solve

However, normally such cellular phone is used at a time of phone call or packet transmission while holding the case of the cellular phone at a certain angle to the ground. Therefore, in the vertical polarization-dominated or horizontal polarization-dominated antenna, it is feared that the deterioration in gain is caused due to inconsistency of the plane of polarization (inconsistency of the main polarization) with an antenna of the base station.

Also, in response to the reed for the expansion of communication area of the cellular phone, the need for the increase of channel capacity, and the like, nowadays the cellular phone (industrial) company that can offer the service at two totally different frequency bands, e.g., 2 GHz band and 800 MHz band, is present. Also, in order to fit the need for the cellular phone that can handle the international roaming in answer to the globalization of communication, and the like, the multi-band cellular phones that can respond to assigned frequency bands to the cellular phone (industrial) companies in respective countries have been developed. However, in case the antenna is equipped every frequency band, such a problem arises that the number of antennas is increased and thus a physical size and a system of the cellular phone are increased. As a result, the development of an antenna that can respond to multiple frequency bands by a single feeding is demanded.

Here, in the cellular phone constructed as shown in FIG. 11, because a simple dipole antenna structure is employed, the current that flows in the longitudinal direction (in FIG. 11, the longitudinal direction) of the case is dominant. For example, when the case is arranged perpendicularly to the ground, the radiation pattern has such a characteristic that the vertical polarization component is dominant. In contrast, since the case is held obliquely to the ground at a time of phone call, packet transmission, or the like, the vertical polarization component is reduced. After all, such a problem arises that the drastic deterioration in gain is caused. Further, such a problem also arises that an increase of SAR is caused because the current is concentrated in the high-frequency power source 105.

Also, in the cellular phone constructed as shown in FIG. 12, because a dipole antenna structure serving as a balanced feeding system is employed, the available bandwidth is narrow. As a result, it is impossible to generate the multi-band resonance in a condition that their resonance frequency bands are largely different.

The present invention has been in view of the above circumstances, and it is an object of the present invention to provide a folding mobile radio device that has a high gain and is capable of reducing a SAR and capable of handling multiple frequency bands.

### Means for Solving the Problems

(1) A folding mobile radio device of the present invention, includes a first case; a second case; a hinge moving portion for joining the first case and the second case turnably; a first antenna element provided in the first case; a second antenna element provided in the first case to intersect substantially orthogonally with the first antenna element, and insulated from the first antenna element; a circuit board provided in the second case to have a ground pattern; a feeding portion connected to a radio circuit provided on the circuit board; and a third antenna element arranged in the second case in close vicinity of or to be connected to one end of the first antenna element, arranged in parallel with the second antenna element, and connected to the feeding portion; wherein the first antenna element and the third antenna element are capacitively or electrically coupled with each other to act as one antenna element, the first antenna element, the third antenna element, and the ground pattern act as a dipole antenna, and the second antenna element and the third antenna element are electromagnetically coupled with each other, and the second antenna element acts as a parasitic element of the third antenna element.

According to this configuration, the broad bandwidth can be obtained by the first antenna element, the third antenna element, and the ground pattern. Also, a well-balanced radiation pattern in both a vertical polarization component and a horizontal polarization component can be formed by the first antenna element that is capacitively coupled or electrically coupled with the third antenna element and the second antenna element that is arranged to intersect substantially orthogonally with the first antenna element and electromagnetically coupled with the third antenna element. As a result, even when the case is held obliquely to the ground at a time of phone call, packet transmission, or the like, the high-gain antenna performance can be always ensured. Also, because the antenna current is induced in the parasitic element of the third antenna element, a current peak portion is reduced by the current distributing effect and also a SAR reduction can be implemented.

(2) Also, in the folding mobile radio device of the present invention, the first case is formed of nonconductive material, and the first antenna element is built in the first case and has a planar shape. According to this configuration, an effective volume of antenna can be increased and also a wideband antenna performance can be ensured.

(3) Also, in the folding mobile radio device of the present invention, the first antenna element is constructed as apart of the first case. According to this configuration, an effective volume of antenna can be increased further and also a wideband antenna performance can be ensured. Also, a thickness reduction or a size reduction of the mobile radio device can be realized by omitting the planar element.

(4) Also, in the folding mobile radio device of the present invention, the first antenna element is arranged in a position that is closer to an opposite side to a side facing to a human body than a center portion of the first case in a thickness direction at a time of phone call. According to this configuration, since the first antenna element can be kept away from a user's cheek, a dielectric loss can be reduced and a high gain can be obtained and also SAR can be reduced.

(5) Also, in the folding mobile radio device of the present invention, the third antenna element is constructed as a part of the second case. According to this configuration, a size reduction of the mobile radio device can be attained, and the configuration coupled with the first antenna element can be facilitated.

(6) Also, in the folding mobile radio device of the present invention, the third antenna element is arranged in a center portion of the second case in a width direction. According to this configuration, since the second antenna element can be kept away from a user's hand holding the side surfaces of the case at a time of phone call, a dielectric loss caused due to a human body can be reduced and thus a high gain can be attained at a time of phone call.

(7) Also, in the folding mobile radio device of the present invention, the third antenna element is arranged in a position that is closer to an opposite side to a side facing to a human body than a center portion of the second case in a thickness direction at a time of phone call. According to this configuration, since the second antenna element can be kept away from a user's face or fingers at a time of phone call, a dielectric loss caused due to a human body can be reduced and thus a high gain can be attained at a time of phone call.

(8) Also, in the folding mobile radio device of the present invention, the third antenna element has both end bent portions whose both end sides are bent, and a length of a portion parallel in a width direction of the case is longer than a total length of both end bent portions. According to this configuration, an electrical length of the third antenna element can be ensured, and a range of a resonance frequency of the third antenna element can be set broadly irrespective of a size of the case.

(9) Also, in the folding mobile radio device of the present invention, a shape of the third antenna element has a meander pattern. According to this configuration, an electrical length of the third antenna element can be ensured, and a range of a resonance frequency of the third antenna element can be set broadly irrespective of a sire of the case.

(10) Also, the folding mobile radio device of the present invention further includes a two-frequency band resonance parasitic element that is constructed by attaching a frequency blocking resonance circuit to one end of the third antenna element and connecting a fourth antenna element having a linear shape, a folded shape, or a meander pattern to the frequency blocking resonance circuit, and resonates with an electrical length of the third antenna element and an electrical length of a sum of the third antenna element and the fourth antenna element. According to this configuration, a frequency at which the polarization component radiated from the third antenna element is dominant can be utilized in two types of largely different frequency bands.

(11) Also, in the folding mobile radio device of the present invention, the first antenna element is shaped such that an area of a portion overlapped with the second antenna element is set to 50° or less of an area of the second antenna element. According to this configuration, interference of the first antenna element on the second antenna element can be reduced, and also a polarization component radiated from the second antenna element can be improved.

(12) Also, in the folding mobile radio device of the present invention, the second antenna element has a shape whose both ends are bent, and a length of a portion parallel in a width direction of the case is longer than a total length of both end bent portions. According to this configuration, an electrical length of the second antenna element can be ensured, and a range of a resonance frequency of the second antenna element can be set broadly irrespective of a size of the case.

(13) Also, in the folding mobile radio device of the present invention, the second antenna element has a meander pattern. According to this configuration, an electrical length of the second antenna element can be ensured, and a range of a resonance frequency of the second antenna element can be set broadly irrespective of a sire of the case.

(14) Also, the folding mobile radio device of the present invention further includes a two-frequency band resonance parasitic element that is constructed by attaching a frequency blocking resonance circuit to one end of the second antenna element and connecting a fifth antenna element having a linear shape, a folded shape, or a meander pattern to the frequency blocking resonance circuit, and resonates with an electrical length of the second antenna element and an electrical length of a sum of the third antenna element and the fifth antenna element. According to this configuration, a frequency at which the polarization component radiated from the second antenna element is dominant can be utilized in two types of largely different frequency bands.

Advantages of the Invention

According to the present invention, the folding mobile radio device such as the folding cellular phone, or the like, which possesses such advantages that a high gain can be implemented and a reduction of SAR can be achieved and which is capable of handling multiple frequency bands, can be provided.

### BRIEF DESCRIPTION OF THE DRAWINGS

FIG. 1 is a rear view showing a folding cellular phone according to a first embodiment of the present invention.

FIG. 2 is a side view showing the folding cellular phone according to the first embodiment of the present invention.

FIG. 3 is a block diagram showing a configuration of the principal part of the folding cellular phone according to the first embodiment of the present invention.

FIG. 4 is an explanatory view showing the VSWR frequency characteristic in the folding cellular phone according to the first embodiment of the present invention.

FIGS. 5A and 5B are explanatory views showing a radiation directivity pattern in the folding cellular phone according to the first embodiment of the present invention. FIG. 5A shows the case where no planar element constituting a second antenna is provided, and FIG. 5B shows the case where the planar element is provided.

FIGS. 6A and 6B are explanatory views showing an SAR distribution in the first embodiment of the present invention. FIG. 6A shows the case where no planar element constituting a second antenna is provided, and FIG. 6B shows the case where the planar element is provided.

FIG. 7 is a side view showing a folding cellular phone according to a second embodiment of the present invention.

FIG. 8 is a rear view showing a folding cellular phone according to a third embodiment of the present invention.

FIG. 9 is a rear view showing a variation of the folding cellular phone according to the third embodiment of the present invention.

FIG. 10 is a rear view showing a folding cellular phone according to a fourth embodiment of the present invention.

FIG. 11 is a side view showing a folding cellular phone into a case of which an antenna unit in the prior art is installed.

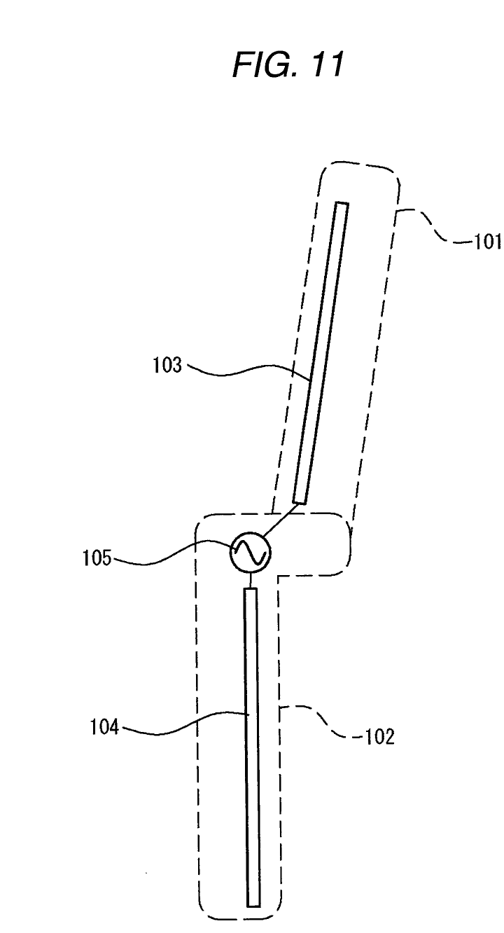

FIG. 12 is a side view showing another folding cellular phone into a case of which an antenna unit in the prior art is installed.

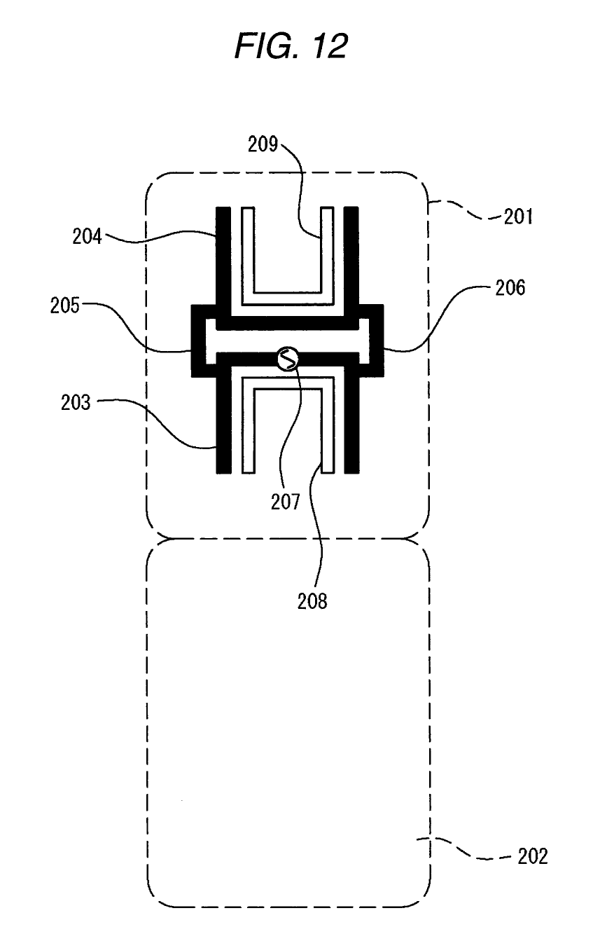

### DESCRIPTION OF REFERENCE NUMERALS

10, 20, 30, 40, 50 folding cellular phone

11 upper case

12 lower case

13 circuit board

14 radio circuit

15 matching circuit

16 planar element (third antenna element)

17 planar element (first antenna element)

18 planar element (second antenna element)

19 hinge moving portion

21 upper case component (first antenna element)

22 planar element (second antenna element)

23 lower case component (third antenna element)

24 feeding component

31 folded type of planar element (second antenna element)

32 folded type of planar element (third antenna element)

41 meander type of planar element (second antenna element)

42 meander type of planar element (third antenna element)

51 planar element (second antenna element)

52 planar element (third antenna element)

53 planar element (fifth antenna element)

54 planar element (fourth antenna element)

55 LC resonance circuit (frequency blocking resonance circuit)

56 LC resonance circuit (frequency blocking resonance circuit)

### BEST MODE FOR CARRYING OUT THE INVENTION

A folding cellular phone as an embodiment of a folding mobile radio device of the present invention will be explained with reference to the accompanying drawings hereinafter.

### FIRST EMBODIMENT

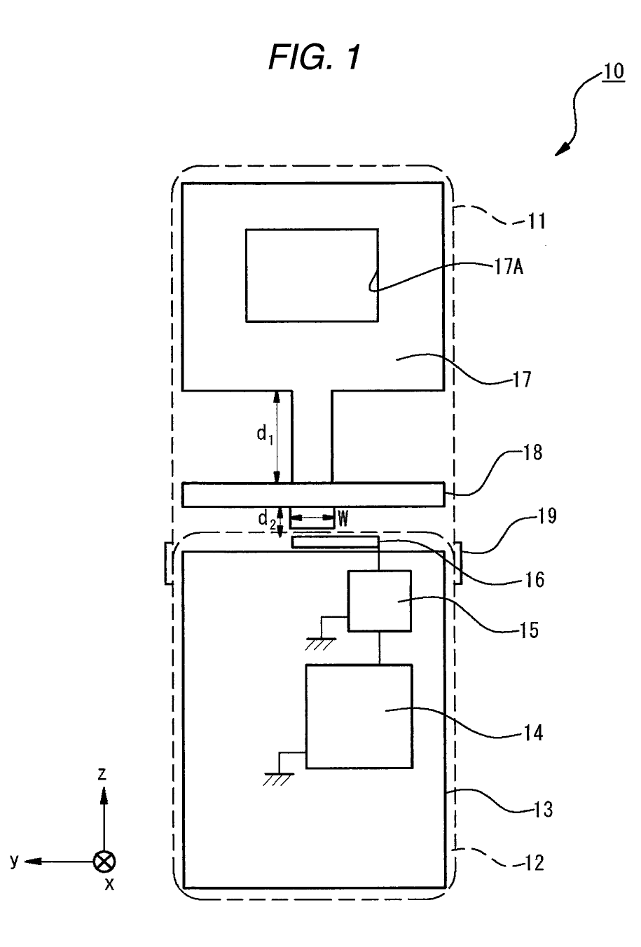

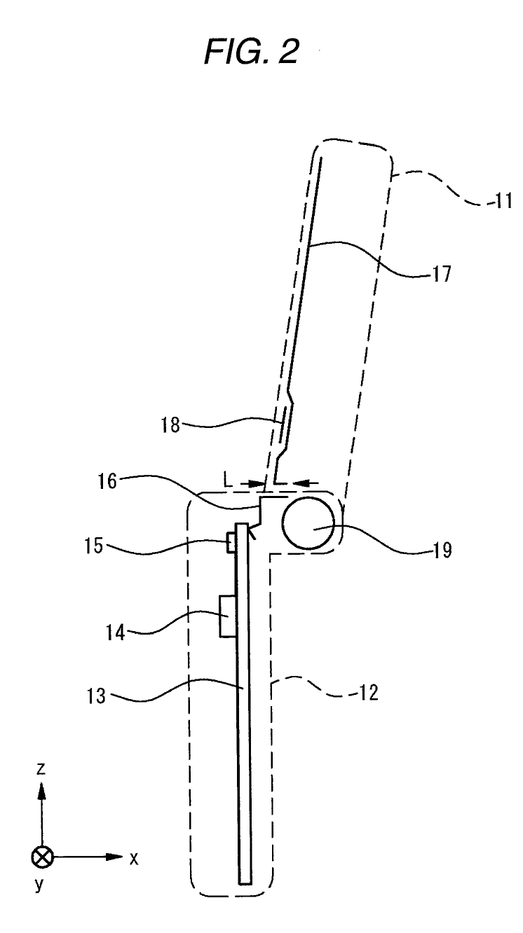

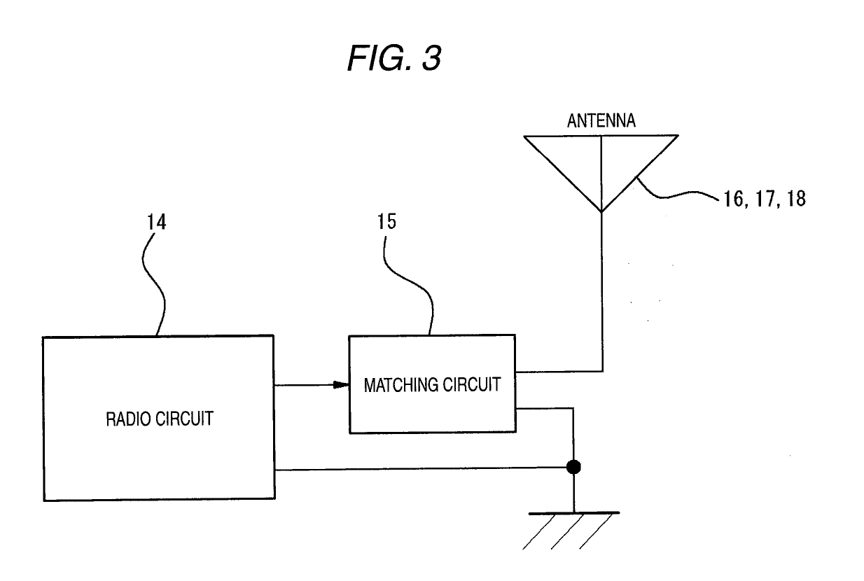

FIG. 1 is a rear view showing a folding cellular phone according to a first embodiment of the present invention. FIG. 2 is a side view showing a basic configuration of the folding cellular phone according to the first embodiment of the present invention. FIG. 3 is a block diagram showing a configuration of the principal part of the folding cellular phone according to the first embodiment of the present invention.

In a folding cellular phone 10 of the present embodiment, the case portion can take two states of its open state and its close state when an upper case 11 constituting a first case and a lower case 12 constituting a second case are turned on a hinge moving portion 19 constituting a coupling portion as a pivot.

The upper case 11 and the lower case 12 constituting the case of the folding cellular phone 10 according to the first embodiment are formed of a resin as an insulating material. Also, a circuit board 13, a radio circuit 14, a matching circuit 15, and a planar element 16 are provided to the lower case 12. Out of them, the circuit board 13 is formed by a ground pattern whose almost entire surface is set to a ground potential of the circuit, and the radio circuit 14 and the matching circuit 15 are mounted on the circuit board 13. The planar element 16 corresponds to a “third antenna element”, is made of the conductive material such as copper, aluminum, or the like, and is arranged in the width direction of the case. The planar element 16 is connected to the matching circuit 15.

A planar element 17 and a planar element 18 are provided to the upper case 11. Out of them, the planar element 17 corresponds to a “first antenna element”, is made of the conductive material such as copper, aluminum, or the like, and is arranged in the longitudinal direction (in FIG. 2, the vertical direction) of the upper case 11. Also, the planar element 17 has a shape in which a clearance 17A is opened under the assumption that a back display component such as LCD, or the like is arranged therein. In contrast, the planar element 18 corresponds to a “second antenna element”, is made of the conductive material such as copper, aluminum, or the like, and is arranged in the width direction of the upper case 11. In order to enhance the electromagnetic coupling with the planar element 16, this planar element 18 is arranged as closely to the planar element 16 as possible, e.g., arranged in parallel with the planar element 16 at a distance d₂=2 mm from the planar element 16.

Also, in order to enhance the electrical coupling with the planar element 16 in the open state, one end of the planar element 17 near the hinge moving portion 19 (this end is referred to as a “top end” hereinafter) is folded (or bent), as shown in FIG. 2. For example, dimensions of the folded portion are set to W=30 mm (see FIG. 1) in the width direction of the case and L=3 mm in the thickness direction of the case. Also, a thickness of the upper case 11 is set to 10 mm. That is, the top end of the planar element 17 is arranged on the inner portion of the upper case 11 in the thickness direction, i.e., arranged in a position that does not face to the user (human body) at a time of phone call. In other words, the top end of the planar element 17 is arranged in the position that is close to the surface (back surface) opposite to the surface (front surface) of the upper case 11 opposing to the user. Further, in order to prevent the interference with the planar element 18, the planar element 17 is insulated from the planar element 18 by an insulating sheet (not shown), or the like. Also, a half area or more of the lower half of the planar element 17 near the top end is cut away to form a narrow-shaped portion, for the radiation from the planar element 18 should have priority in the overlapping area between the planar element 17 and the planar element 18. For example, in the present embodiment, in FIG. 1, the lower half of the planar element 17 is cut off largely in such a fashion that a distance of about d₁=10 mm can be kept between respective parallel sides of the planar element 17 and the planar element 18.

Next, an operation of the antenna having such configuration in the present embodiment will be explained hereunder.

First, the case is set in its open state, and a power source (not shown) is turned ON. Then, as shown in FIG. 3, the radio circuit 14 and the matching circuit 15 are turned ON, and a power is fed from a high-frequency power source (not shown) to the planar element 16. At this time, as shown in FIG. 2, the planar element 16 and the planar element 17 are coupled by the electrical coupling or the capacitive coupling because they are positioned in very close vicinity, and both the planar element 16 and the planar element 17 act as one element. Thus, the planar element 16, the planar element 17, and the ground pattern of the circuit board 13 act as one dipole antenna. In this case, an antenna area of the planar element 17 is large, the wideband antenna performance can be ensured when the planar element 17 is electrically (or capacitively) coupled with the planar element 16 to which a power is fed.

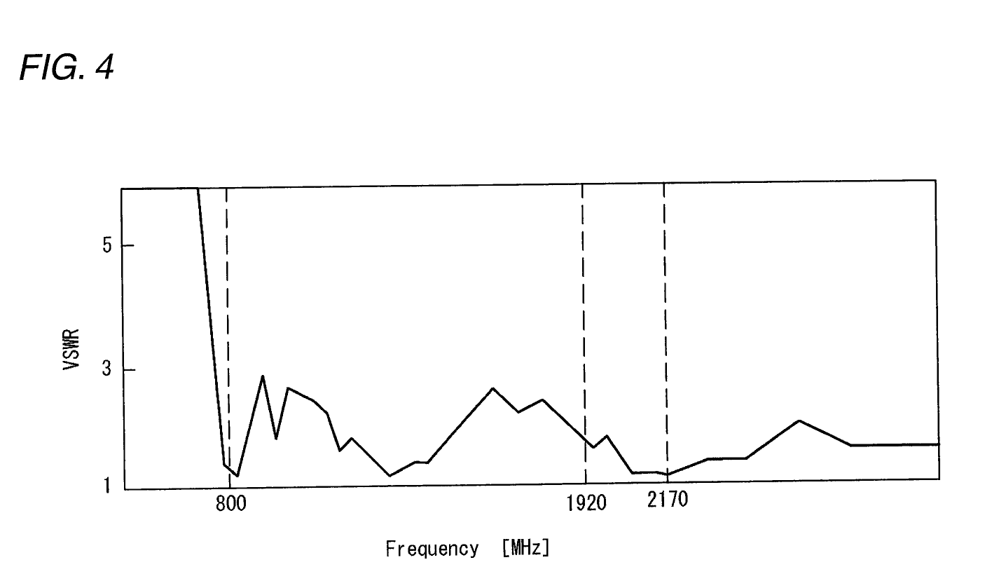

Here, the VSWR characteristic of the antenna of the folding cellular phone 10 shown in FIG. 1 is shown in FIG. 4. According to this FIG. 4, it is understood that the good VSWR characteristic was brought about from 800 MHz band to 2 GHz band.

Also, because a length of the planar element 17 is dominant in the longitudinal direction of the upper case 11, the folding cellular phone 10 of the present embodiment executes the antenna operation in such a way that the vertical polarization component is dominant when the upper case 11 and the lower case 12 are positioned perpendicularly to the ground. Also, because the planar element 16 is positioned at the center in the width direction of the lower case 12, the deterioration of gain can be prevented when the side surfaces of the lower case 12 (both right and left side surfaces in FIG. 1, or the surfaces that are in parallel with a surface of a sheet in FIG. 2) not to be positioned at the center portion in the width direction are held with the fingers.

Also, the planar element 18 when coupled with the planar element 16 via the electromagnetic coupling acts as the parasitic element. The planar element 18 acts as a wave director at a desired frequency f1 by adjusting an electrical length to radiate a radio wave on the opposite (back surface) side (in FIG. 1 and FIG. 2, −x direction) to the surface (front surface) opposing to the user (human body), so that the deterioration of gain can be prevented. Also, because an antenna current of the planar element 18 flews in the width direction of the upper case 11, a high gain can be obtained even when the case is leaned at a time of phone call such that not the longitudinal direction of the case but the width direction of the case is set perpendicular to the ground.

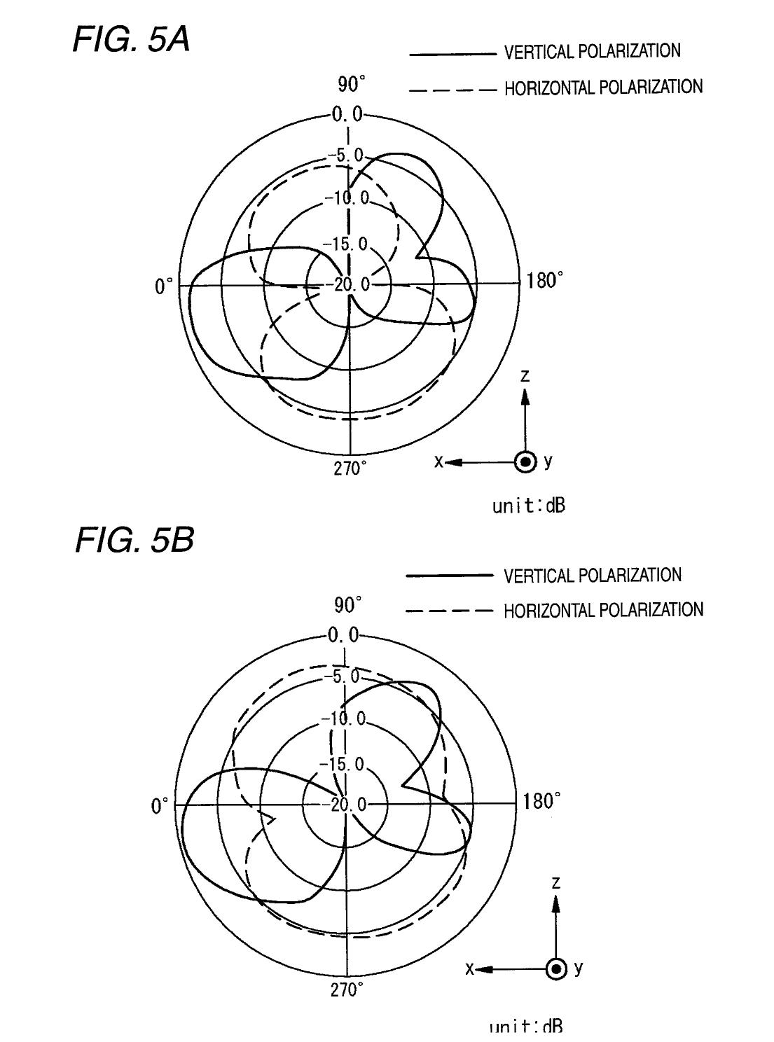

Here, radiation patterns (where the frequency band is 2170 MHz band) are shown in FIGS. 5A and 5B. In this case, FIG. 5A shows the case where the planar element 18 is not provided, and FIG. 5B shows the case where the planar element 18 is provided.

According to FIGS. 5A and 5B, it is appreciated that, because the planar element 18 is provided, the horizontal polarization component was improved by about 2 dB and the vertical polarization and the horizontal polarization were well balanced.

Also, since the antenna current is induced in the planar element 18 at a frequency f1, a peak value of the maximum current flowing through the planar element 16 is reduced. Hence, this planar element 18 also fulfills a role of the SAR reducing effect.

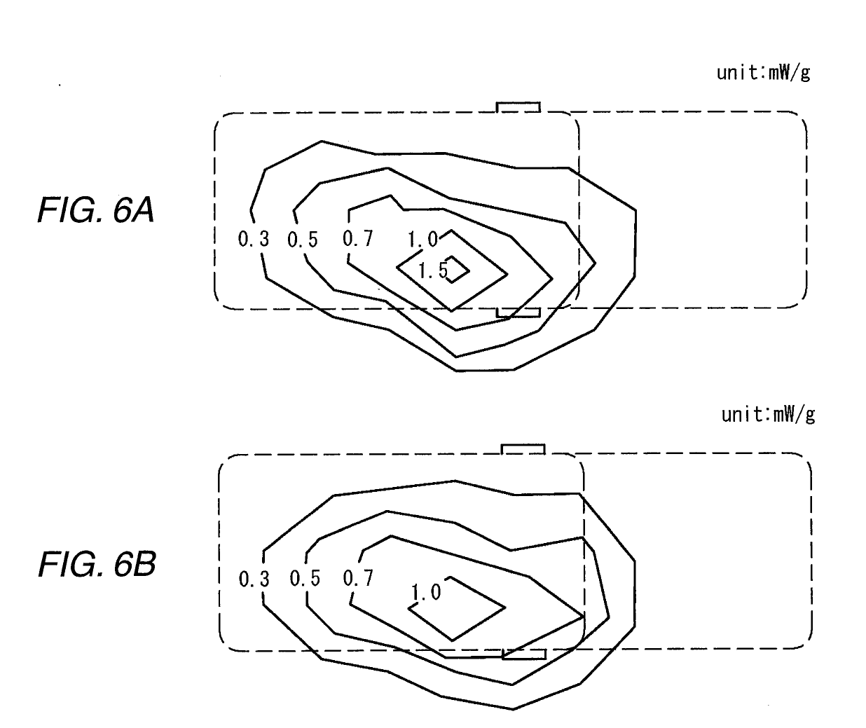

Here, SAR distributions (where the frequency band is 1920 MHz band) are shown in FIGS. 6A and 6B. In this case, FIG. 6A shows the case where the planar element 18 is not provided, and FIG. 6B shows the case where the planar element 18 is provided.

According to FIGS. 6A and 6B, it is appreciated that, because the planar element 18 is provided, the SAR value was reduced and in particular a reduction of about 25% was found.

In this manner, according to the folding cellular phone of the present embodiment, since the planar element 17 through which the antenna current flows in the longitudinal direction of the case when the case is opened and the planar element 18 through which the antenna current flows in the width direction of the case when the case is opened are provided, the deterioration due to the inconsistency of the main polarization is hard to occur even though the case is held to tilt at any angle. Therefore, a high gain can be obtained.

Also, according to the present embodiment, as described above, the planar element 17 is arranged on the back surface side that does not face to the user (human body) at a time of phone call, and the planar element 16 is arranged at the center portion, which does not come close to the user (human body) at a time of holding the side surfaces of the case during the phone call, in the width direction of the case. Therefore, a high gain can be obtained even at a time of phone call during which the user (human body) comes close to the cellular phone.

In addition, since the antenna current is induced in the planar element 18 from the planar element 16 as the feeding element, the current distributing effect is brought about. Therefore, the SAR can be reduced and thus the good antenna characteristics can be obtained.

### SECOND EMBODIMENT

Next, a folding cellular phone according to a second embodiment of the present invention will be explained hereunder.

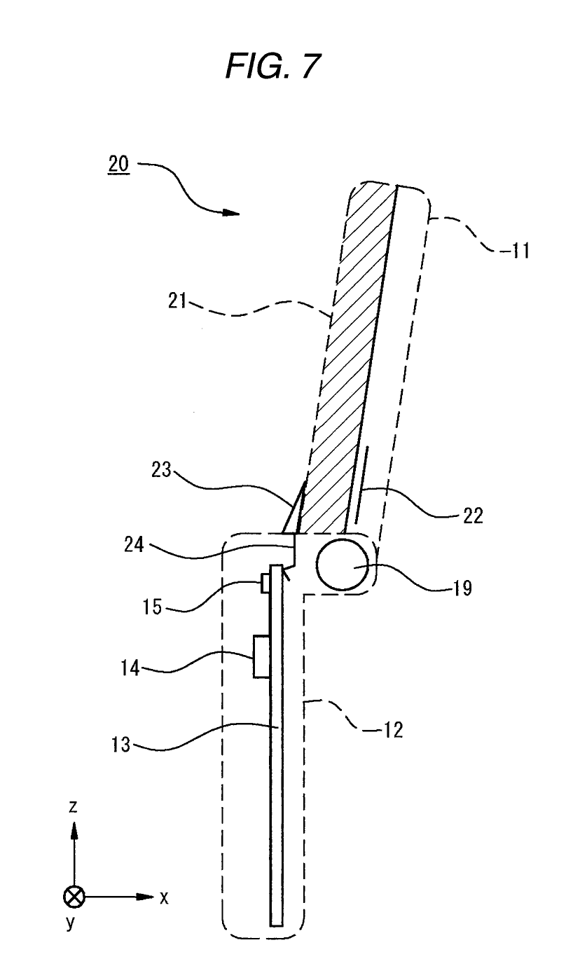

FIG. 7 is a side view showing a basic configuration of a folding cellular phone according to a second embodiment of the present invention. In FIG. 7, the same symbols are affixed to portions that have the same basic configurations as those in the first embodiment, and their explanation will be omitted herein.

A folding cellular phone 20 of the present embodiment is different from the first embodiment in that an upper case component 21 (constituting the first antenna element) and a planar element 22 (constituting the second antenna element) are provided to the upper case 11 instead of the planar element 17 and the planar element 18 respectively, and a lower case component 23 (constituting the third antenna element) is provided to the lower case 12 instead of the planar element 16.

The upper case component 21 is formed of the conductive material such as copper, aluminum, or the like, and constitutes a part of the upper case 11. The planar element 22 is formed of the conductive material such as copper, aluminum, or the like, is insulated from the upper case component 21, and is arranged in the width direction of the upper case 11.

Also, the lower case component 23 is formed of the conductive material such as copper, aluminum, or the like, and constitutes a part of the lower case 12. The lower case component 23 is connected to the matching circuit 15 mounted on the circuit board 13 via a feeding component 24 formed of the conductive material.

As described above, according to the folding cellular phone 20 according to the second embodiment of the present invention, the planar element 17 in the folding cellular phone 10 of the first embodiment is replaced with the upper case component 21 and the planar element 16 is replaced with the lower case component 23. Therefore, a space required for arrangement of theses elements can be saved and thus a size reduction of the case can be attained.

In the above explanation, an example in which the planar element 16 is constructed by the lower case component 23 is explained. For example, even when the planar element 16 is replaced with the print pattern on the circuit board 13 or the planar element 17 is replaced with the conductive component such as a vibrator, or the like, the present embodiment can also be carried out. In this event, this conductive component is arranged near the top end of the planar element 17, and terminals ((+) terminal and (−) terminal) of this conductive component are cut off in the high-frequency range via a component such as an inductor, or the like, and a power is fed to one terminal (e.g., (+) terminal) of this conductive component.

### THIRD EMBODIMENT

Next, a folding cellular phone 30 according to a third embodiment of the present invention and a folding cellular phone 40 according to a variation thereof will be explained hereunder.

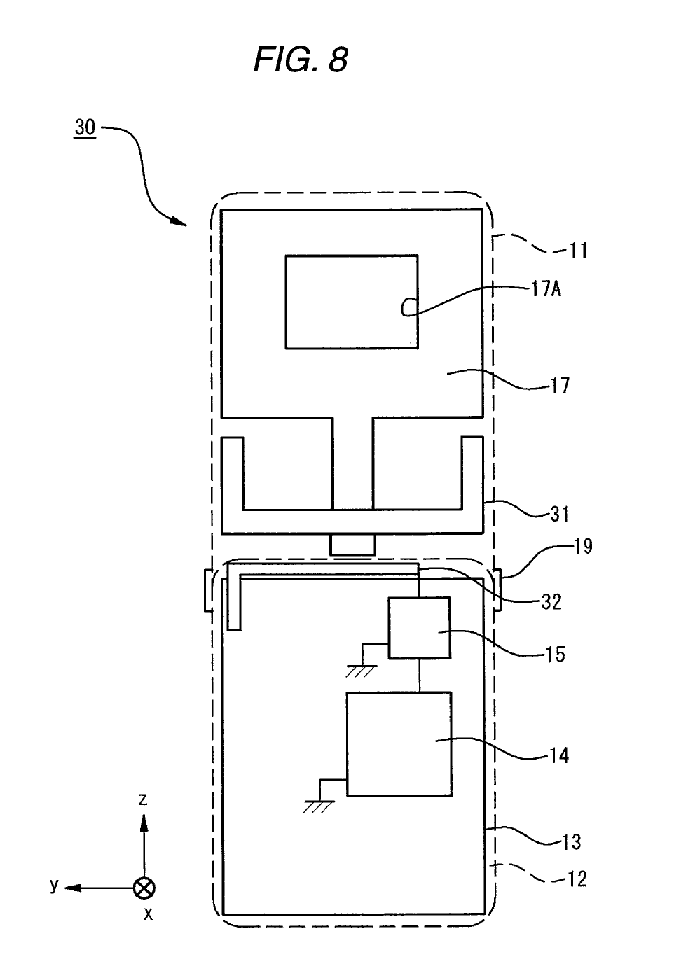

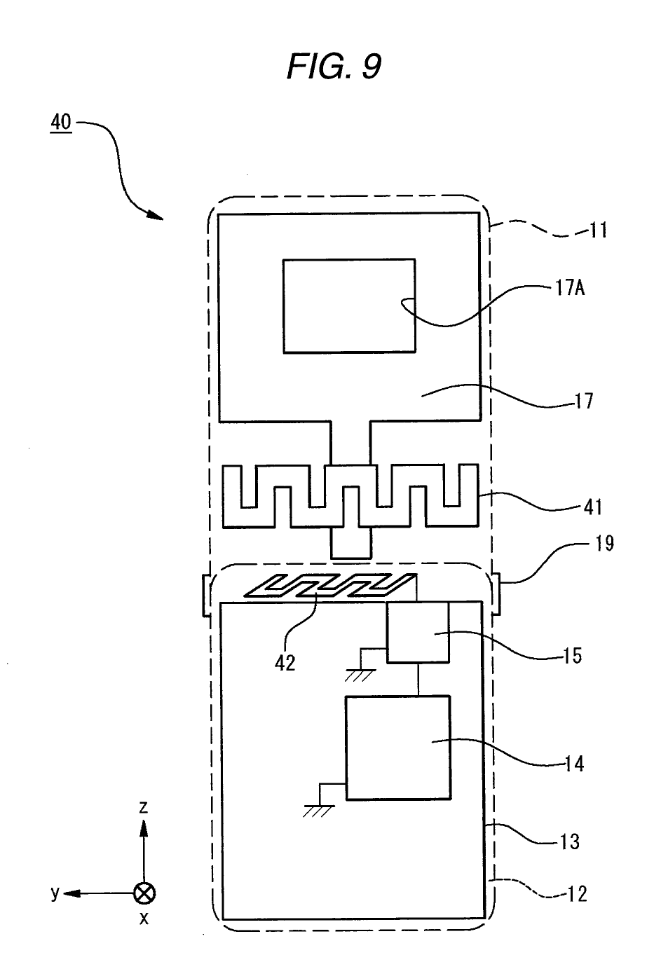

FIG. 8 is a rear view showing a basic configuration of the folding cellular phone 30 according to the third embodiment. FIG. 9 is a rear view showing the folding cellular phone 40 according to the variation of the third embodiment. In FIG. 8 and FIG. 9, the same symbols are affixed to portions that have the same basic configurations as those in the first and second embodiments, and their explanation will be omitted herein.

A configuration of the folding cellular phone 30 of the present embodiment is substantially identical to that of the second embodiment shown in FIG. 7. However, as shown in FIG. 8, a folded type of planar element 31 constituting the “second antenna element” and a folded type of planar element 32 constituting the “third antenna element” are provided such that they are bent in the longitudinal direction of the case respectively.

In this planar element 31 (also the planar element 32), a length in the width direction of the case is dominant. Since the planar element 31 is bent in the longitudinal direction of the case like the present embodiment, an electrical length of the planar element 31 can be extended longer than the planar element 18 (whose shape is linear) constituting the second antenna element provided in the first embodiment. Thus, a desired frequency range can be expanded.

Meanwhile, as shown in FIG. 9, in the folding cellular phone 40 according to the variation of the present embodiment, a planar element 41 constituting the “second antenna element” and a planar element 42 constituting the “third antenna element” are constructed to have a meander pattern respectively. In this manner, an electrical length of the planar element 41 and the planar element 42 can be extended further longer respectively by shaping them into the meander pattern. Thus, a desired frequency range can be expanded further.

Moreover, in the folding cellular phone 30 of the present embodiment above in FIG. 8 (or the folding cellular phone 40 of the variation shown in FIG. 9), when one of the planar element 31 and the planar element 32 (or the planar element 41 and the planar element 42) being shaped as the folded shape and the other thereof being shaped into the meander pattern are employed in combination, a long electrical length can also be ensured.

Therefore, according to the present embodiment (or the variation), for example, when a width of the case of the folding cellular phone 30 (or the folding cellular phone 40) is 50 mm and also the planar element 31 and the planar element 32 (or the planar element 41 and the planar element 42) as the parasitic element are operated as a wave director that resonates by a half-wave λ/2) length at a frequency 800 MHz band, a length of about 180 mm is required of the planar element 31 and the planar element 32 (or the planar element 41 and the planar element 42). As a result, it is impossible to ensure an electrical length only by a length corresponding to a width of the case. For this reason, in the present embodiment, as shown in FIG. 8 or FIG. 9, a long electrical length can also be ensured by employing the folded shape or the meander pattern.

### FOURTH EMBODIMENT

Next, a folding cellular phone 50 according to a fourth embodiment of the present invention will be explained hereunder.

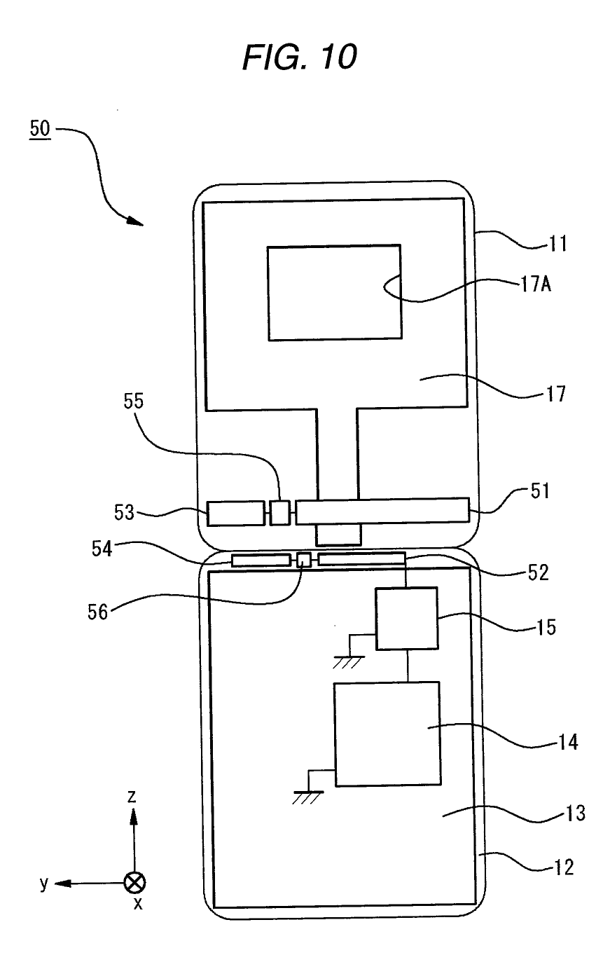

FIG. 10 is a rear view showing a basic configuration of a folding cellular phone according to the fourth embodiment of the present invention. In FIG. 10, the same symbols are affixed to portions that have the same basic configurations as those in the first to third embodiments, and their explanation will be omitted herein.

In the folding cellular phone 50 of the present embodiment, as shown in FIG. 10, a planar element 54 constituting a “fourth antenna element” and a planar element 53 constituting a “fifth antenna element” as well as a planar element 51 constituting the “second antenna element” and a planar element 52 constituting the “third antenna element” are provided. Also, an LC resonance circuit 55 serving as a frequency blocking resonance circuit is provided between the planar element 51 and the planar element 53, and also an LC resonance circuit 56 serving as a frequency blocking resonance circuit is provided between the planar element 52 and the planar element 54.

In this manner, in the present embodiment, the LC resonance circuit 55 is connected between the planar element 51 corresponding to the second antenna element and the planar element 53 corresponding to the fifth antenna element. Therefore, the two-frequency band resonance parasitic element that can resonate at two different frequency bands consisting of a desired frequency (f2) corresponding to an electrical length of the planar element 51 and a desired frequency (f3) corresponding to a sum of electrical lengths of the planar element 51 and the planar element 53 can be provided.

Also, similarly the LC resonance circuit 56 is connected between fine planar element 52 corresponding to the third antenna element and the planar element 54 corresponding to the fourth antenna element. Therefore, the two-frequency band resonance parasitic element that can resonate at two different frequency bands consisting of a frequency corresponding to an electrical length of the planar element 52 (equal to the frequency corresponding to the electrical length of the planar element 51, f2) and a frequency corresponding to a sum of electrical lengths of the planar element 52 and the planar element 54 (equal to the frequency corresponding to the sum of electrical lengths of the planar element 51 and the planar element 53, f3) can be provided.

At this time, since the planar element 51, the planar element 52, an element as a sum of the planar element 51 and the planar element 53, and an element as a sum of the planar element 52 and the planar element 54 are coupled electromagnetically respectively, a component of a radiation electric field in the width direction of the case is enhanced at two types of different frequency bands f2, f3. At this time, the planar element 51 has an about λ/2) length at the frequency f2, the element as a sum of the planar element 51 and the planar element 53 has an about (λ/2) length at the frequency f3, the planar element 52 has an about (3λ/8) length at the frequency f2, and the element as a sum of the planar element 51 and the planar element 53 has an about (3λ/8) length at the frequency f3.

As described above, because the LC resonance circuit is connected to two planar elements, a radio wave can be radiated from the antenna in the width, direction of the case at two types of different frequency bands. As a result, the antenna capable of resonating in multiple frequency bands by a single feeding can be implemented.

Also, in the present invention, for example, when the planar element 22, the planar element 32, the planar element 41, the planar element 51, etc. cannot ensure a predetermined electrical length only in the width direction of the case, a desired electrical length can be ensured by employing the folded shape in the longitudinal direction of the case or the meander pattern in combination.

Here, the present invention is not limited to above embodiments at all, and can be carried out in various modes within a scope that does not depart from a gist.

### INDUSTRIAL APPLICABILITY

The folding mobile radio device of the present invention possesses such advantages that, even when the case is held to tilt at any angle to the ground, a nigh gain can be still implemented and a reduction of SAR can be still achieved and also frequencies in multiple bands can be handled, and is useful to the folding cellular phone that is compatible with the international roaming, and the like.

1. A folding mobile radio device, comprising:
a first case;
a second case;
a hinge moving portion for joining the first case and the second case turnably;
a first antenna element provided in the first case;
a second antenna element provided in the first case to intersect substantially orthogonally with the first antenna element, and insulated from the first antenna element;
a circuit board provided in the second case to have a ground pattern;
a feeding portion connected to a radio circuit provided on the circuit board; and
a third antenna element arranged in the second case in close vicinity of or to be connected to one end of the first antenna element, arranged in parallel with the second antenna element, and connected to the feeding portion;
wherein the first antenna element and the third antenna element are capacitively or electrically coupled with each other to act as one antenna element,
the first antenna element, the third antenna element, and the ground pattern act as a dipole antenna, and
the second antenna element and the third antenna element are electromagnetically coupled with each other, and the second antenna element acts as a parasitic element of the third antenna element.

2. A folding mobile radio device according to claim 1, wherein the first case is formed of nonconductive material, and
the first antenna element is built in the first case and has a planar shape.

3. A folding mobile radio device according to claim 1, wherein the first antenna element is constructed as a part of the first case.

4. A folding mobile radio device according to claim 1, wherein the first antenna element is arranged in a position that is closer to an opposite side to a side facing to a human body than a center portion of the first case in a thickness direction at a time of phone call.

5. A folding mobile radio device according to claim 1, wherein the third antenna element is constructed as a part of the second case.

6. A folding mobile radio device according to claim 1, wherein the third antenna element is arranged in a center portion of the second case in a width direction.

7. A folding mobile radio device according to claim 1, wherein the third antenna element is arranged in a position that is closer to an opposite side to a side facing to a human body than a center portion of the second case in a thickness direction at a time of phone call.

8. A folding mobile radio device according to claim 1, wherein the third antenna element has both end bent portions whose both end sides are bent, and a length of a portion parallel in a width direction of the case is longer than a total length of both end bent portions.

9. A folding mobile radio device according to claim 1, wherein a shape of the third antenna element has a meander pattern.

10. A folding mobile radio device according to claim 1 further comprising:
a two-frequency band resonance parasitic element that is constructed by attaching a frequency blocking resonance circuit to one end of the third antenna element and connecting a fourth antenna element having a linear shape, a folded shape, or a meander pattern to the frequency blocking resonance circuit, and resonates with an electrical length of the third antenna element and an electrical length of a sum of the third antenna element and the fourth antenna element.

11. A folding mobile radio device according to claim 1, wherein the first antenna element is shaped such that an area of a portion overlapped with the second antenna element is set to 50% or less of an area of the second antenna element.

12. A folding mobile radio device according to claim 1, wherein the second antenna element has a shape whose both ends are bent, and a length of a portion parallel in a width direction of the case is longer than a total length of both end bent portions.

13. A folding mobile radio device according to claim 1, wherein the second antenna element has a meander pattern.

14. A folding mobile radio device according to claim 1, further comprising:
a two-frequency band resonance parasitic element that is constructed by attaching a frequency blocking resonance circuit to one end of the second antenna element and connecting a fifth antenna element having a linear shape, a folded shape, or a meander pattern to the frequency blocking resonance circuit, and resonates with an electrical length of the second antenna element and an electrical length of a sum of the third antenna element and the fifth antenna element.
